(19) United States
(12) Patent Application Publication
(10) Pub. No.: US 2009/0027177 A1
(43) Pub. Date: Jan. 29, 2009

(54) Processor Controlled Adaptive Safety System with Remote Shutdown

(76) Inventor: David John Hodder, Idaho Falls, ID (US)

Correspondence Address: DAVID JOHN HODDER, 231 STILLWATER DR., IDAHO FALLS, ID, 83404, US

(21) Appl. No.: 11/829,903

(22) Filed: Jul. 28, 2007

(51) Int. Cl. B60R 25/10

(52) U.S. Cl. 340/426.12; 340/426.11

(57) ABSTRACT

The present invention is a Processor Controlled Adaptive Safety System intended for personal vehicles such as All Terrain Vehicles (ATVs), golf carts, personal watercraft, and snow machines. Additionally it may be implemented on manufacturing and industrial processes. This invention uses a microprocessor and associated program to evaluate the vehicle/system operator and onboard system sensors to determine whether the operator is qualified. If the operator is not qualified the unit will disable or reduce the performance of said vehicle or system. The said invention also incorporates a wireless remote shutdown system to provide a qualified owner/operator with the option of disabling the vehicle or system remotely. The objective of this invention is to prevent accidents to elderly, teen age and pre teen-age children, and workers, and act as an anti theft device.

### BACKGROUND OF THE INVENTION

1. Field of the Invention

This invention relates generally to a safety system used on electromechanical vehicles. This invention will determine the qualifications of the operator and based on these qualifications this device will enable or disable the vehicle. Additionally this invention incorporates a remote deactivation apparatus whereby an observer may remotely deactivate the vehicle should a dangerous event occur, or appear likely to occur. This invention will also deter theft of said vehicle by disabling the vehicle via a remote deactivation apparatus, or by the operator's actions.

2. Description of the Related Art

Recreational vehicles are enjoying a widespread popularity throughout the world. Recreational vehicles such as the all-terrain vehicle (ATV) are opening up National Parks and backcountry to more and more visitors. As these vehicles become more popular they are coming with more powerful engines, all-wheel drive, and a selection of options to improve their utilitarian use and off road appeal. Additionally with this widespread popularity, the overall experience level of the operators has gone down. This is due to the fact that more riders have little or no training and experience in operating vehicles on rough terrain. This class of operators includes elderly, young teenagers, and pre-teenage children. Add the rough terrain that these vehicles typically ride over, the added horsepower of the engines, coupled with the general lack of training and experience of many riders, and this is a recipe for tragedy.

In most locations it is legal for children to operate these vehicles. And as long as they are not operated on public roadways there is no licensing requirement. And where there are licensing requirements, laws are typically difficult to enforce due to the nature of the vehicles use.

There have been many documented incidences where a young inexperienced rider has gotten on a recreational vehicle and while playing with it, either started it or engaged it in gear. Usually a horrified parent or onlooker watches as the vehicle speeds away with a child on it concluding with the inevitable crash or rollover. These accidents result in injury and death to the child. The typical throttle design is counterintuitive to stopping said vehicle. As the child or inexperienced rider becomes more frightened they squeeze the handgrips tighter, resulting in the throttle opening and the vehicle speeding up.

This invention is designed to provide a level of safety wherein the operator's actions if incorrect, will disable the vehicle. Additionally there is a remote deactivation device that a qualified vehicle owner/operator may use to disable the vehicle at any time.

The prior art consist of a wide assortment of devices that are intended to disable the engine or vehicle by electrical or mechanical means. U.S. Pat. No. 7,068,152 to Hager, wherein the inventor describes a remote deactivation system comprised of a RF transmitter and receiver wherein any parent or adult may initiate a remote power down to the vehicle via a combination transmitter and receiver. This system is a basic electromechanical ignition interrupter circuit whereby once the receiver initiates that shut down it controls a relay to ground the ignition system. This system has redundant power supplies on the vehicle and a visual and audible alarm when it is engaged. Remote initiation is accomplished by a wireless key fob type device.

U.S. Pat. No. 6,349,786 to Gift wherein the inventor describes an emergency stopping mechanism for disabling the engine of an ATV operated by child. The system uses a mechanical toggle switch connected to the engine kill system. The system is easily defeated and suffers from the longevity of the mechanical switch used.

U.S. Pat. No. 5,608,272 to Tanguay. This patent is for an antitheft device that is microprocessor controlled. This device provides two levels of security. One is the initial starting of the vehicle must be done using a key chip. The key chip data is compared to data stored on an EPROM memory. If the key chip code correlates to a preprogrammed code in the EPROM, the vehicle and its' security system runs normally. If the EPROM sees the wrong code it disables the vehicle. An additional feature of this invention is if the driver is carjacked they can disable the vehicle while getting out of the car. Typically this involves the driver pumping the brake pedal twice and opening the door within a predetermined time. Once this occurs within 60 seconds the vehicle fuel system is shut down and the vehicle engine quits running, disabling the vehicle. In order to re-enable the vehicle the operator must know the location of a reset switch. This system also has provisions for a fleet wide Master Key type of remote keyless entry via a master controller chip and sensor.

While there has been a lot of effort devoted to designing automotive security systems and anti-hijacking systems there has been little effort to designing safety systems in any type of vehicle that takes into account the actions of the operator in determining whether said operator is qualified. This invention illustrates an adaptable and cost-effective method of providing an additional layer of safety to the operation of personal vehicles.

### SUMMARY OF THE INVENTION

It is the objective of this invention to provide a method of disabling a vehicle based on evaluated operator qualifications and/or experience.

It is also an objective of this invention to provide a remote deactivation system based on a radio frequency (RF) transmitter and receiver.

It is also an objective of this invention to provide an integral antitheft system via the operator's algorithm, and a remote deactivation device.

It is also an objective of this invention that it is flexible and easily adaptable to many different types of personal vehicles such as, but not limited to, ATV, snow machine, golf carts, riding lawn mowers, electric carts, watercraft, and airborne vehicles. This invention is also less complicated, more economical, and more flexible than the prior art as described above and cited herein.

It is also an objective of this invention to utilize existing vehicle controls and indicators as system input sensors, providing additional robustness and ease of implementation by eliminating custom installed sensors.

The method of the present invention is to utilize a microprocessor-based evaluation system that takes input from operator action, and onboard sensors. The microprocessor-based evaluation system utilizes an adaptive algorithm that performs real-time analysis and decision-making based on the general operating parameters of the vehicle in stored in memory, current user actions, and sensor statuses. The microprocessor determines whether to allow the vehicle to run normally, degrade the vehicle performance, or disable the vehicle.

### BRIEF DESCRIPTION OF THE DRAWINGS

FIG. 1 is a schematic illustration of the invention showing the major components and one-line interconnections.

FIG. 2 is a flow chart illustrating the invention's decision algorithm.

### DETAILED DESCRIPTION OF THE PREFERRED EMBODIMENT

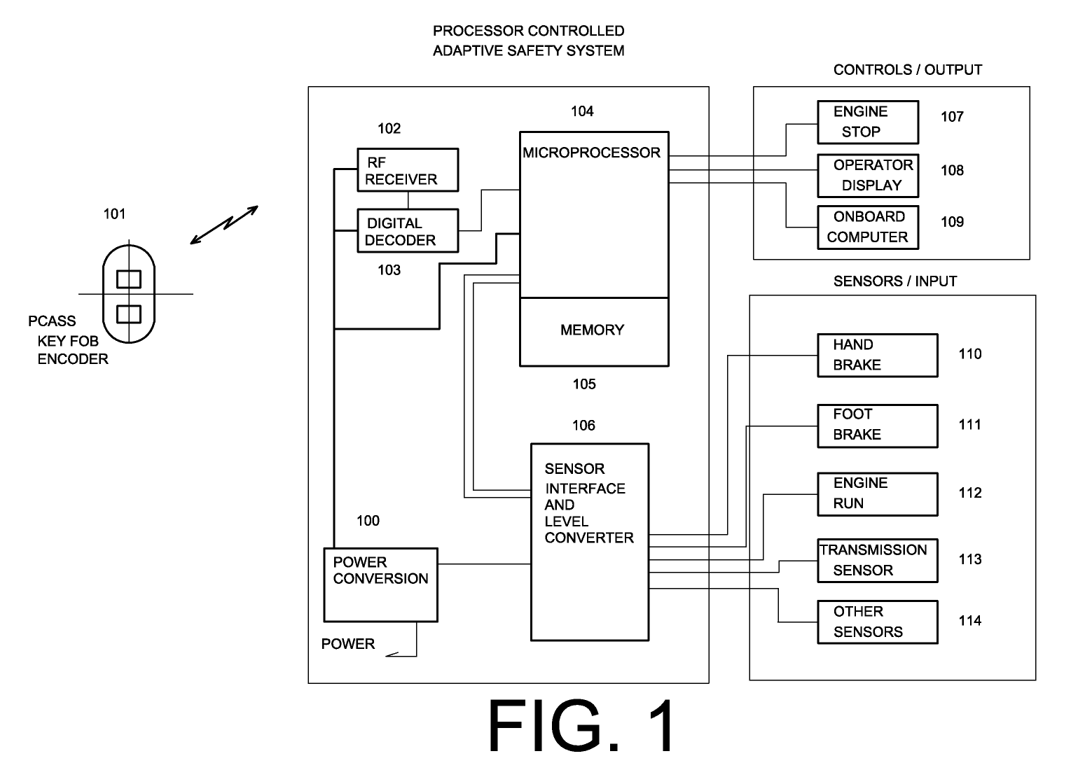

A. The Processor Controlled Adaptive Safety System (PCASS) consists of a hardware component, and software component. FIG. 1 shows the major components, subcomponents, and the logical connections of the hardware portion of the preferred embodiment, although many other layouts and embodiments are possible.

1. Sensors and Input.

The sensors and input section consists of external sensor inputs that the PCASS processor unit evaluates in real time. The logic input levels from the vehicle are typically between 11.5 and 14 V DC. These inputs include but are not limited to the following:

(110) Is the hand brake input. This input provides status as to the condition of either the right or left hand brake. (111) Is the foot brake input. This input provides the status of the foot brake. (112) The engine run status input. The engine status input provides the unit with the current run condition of the engine. (113) The input from the transmission selector. This input provides the unit with the position of the gear selector lever that controls the transmission. (114) Is reserved for other sensors and future inputs.

2. PCASS System

The PCASS system consists of a power conversion unit (100). The power conversion unit draws its' power from the vehicle battery system via the ignition switch or battery terminals. When the ignition switch is turned on power is provided to the power conversion unit where the nominal 12 VDC battery power is converted to the required voltages for the PCASS system components. These voltages typically range from 3 V to 5 V DC. The power conversion unit powers the RF receiver (102), the Digital decoder (103), the sensor interface and level converter (106), the microprocessor (104), and the system memory (105).

The RF receiver (102), receives the encoded radio frequency signal from the PCASS key fob (101), it is a highly sensitive RF receiver with an automatic gain control circuit that provides for extended receive range for the key fob of encoder (101). The RF receiver converts the radio frequency signal to base band digital encoded words that are then sent to the digital decoder (103). The digital decoder (103) decodes the digital bit stream from the RF receiver. The digital decoder (103) first determines if PCASS key fob encoder (101) has the proper security code for this PCASS system. The digital decoder then decodes the command that was sent to it and sends the results to the microprocessor (104) for action. The digital decoder (103) may also be configured so that it passes the incoming security code, and commands directly to the microprocessor (104).

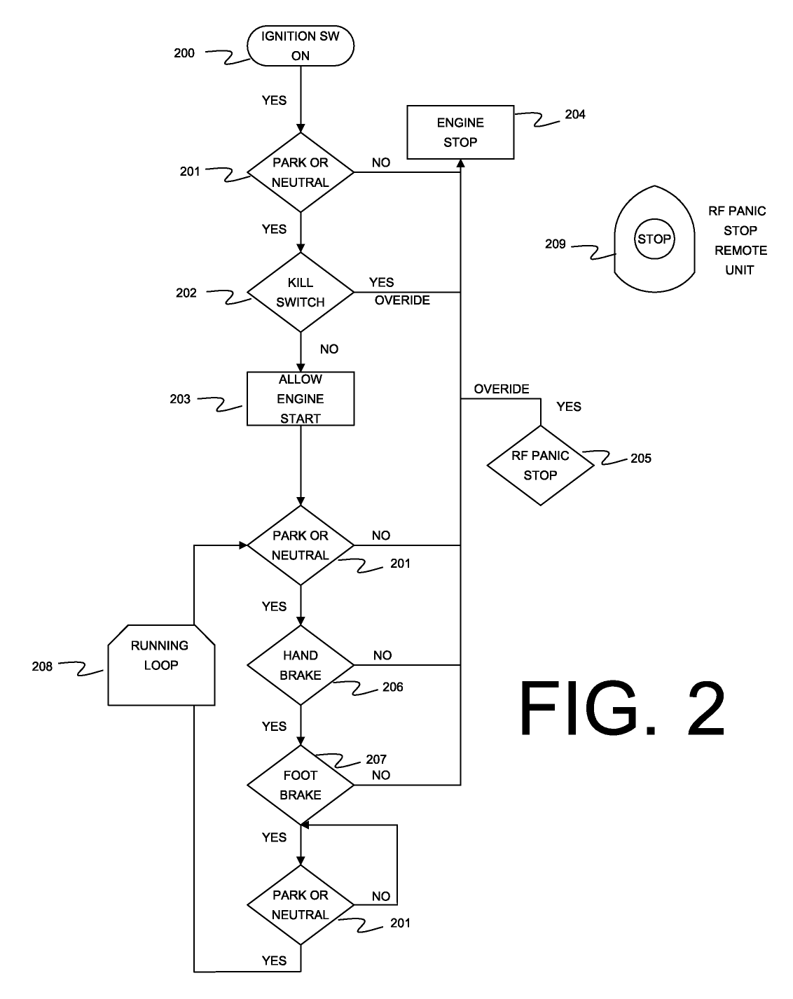

The microprocessor (104) consists of registers, fast memory, and the CPU unit. The microprocessor is where the program resides and runs. The microprocessor has nonvolatile memory where the program can be stored indefinitely, and may have volatile read/write memory (105) were real-time data is stored and utilized. FIG. 2 is the algorithm of the software program. The microprocessor has input from the sensor interface and level converter (106), and the digital decoder (103). These inputs are stored in memory (105), where the software program accesses and manipulates the stored data as needed.

Based on the data the microprocessor (104) receives from the vehicle system, and referring to the decision algorithm shown in FIG. 2, it issues commands to the controls and output section. These commands can be routed to any combination of engine commands (107), operator displays (108), or onboard computer inputs (109). These outputs may consist of engine controls such as stop or decrease RPMs to the engine command module (107), operator messages to operator display (108) such as, PCASS system status. This display may include but not limited to what sensor or input initiated an engine shut down or stop command, and real-time sensor status. Additionally microprocessor output can be fed to the vehicle's onboard computer (109) such as a CDI module or engine control module (ECM), if so equipped. Information that is provided can be used by the vehicle's onboard computer to initiate engine or system controls such as reduced RPMs, shift override, or engine stop commands, as well as sensor fault codes.

3. Controls and Output

The microprocessor (104) provides output signaling that depending on the design of the vehicle will initiate an engine stop engine command (107) under fault. This is typically done by opening or closing an engine stop signal. Optionally it may be sent to an onboard computer (109) as an engine stop signal. If the vehicle is equipped with a higher-level onboard computer (109) for running the engine and transmission, the microprocessor (104) can initiate engine stop, RPMs slowdown, and transmission select override, as deemed appropriate by the software loaded in the microprocessor (104). The microprocessor system is capable of interfacing with a simple capacitor discharge ignition system (CDI) or a complex electronic control module (ECM). This would be a make and model specific program adaptation of the microprocessor (104) software.

4. Key-FOB Encoder

The keep fob encoder (101) is a separate device that can be clipped on to clothing or handheld. The purpose of the key fob is to provide a responsible party with the ability to shut off the vehicle remotely. This is useful in preventing unauthorized riders from operating the vehicle. It is also useful when a novice vehicle operator is learning how to operate a vehicle and it must be shut down externally to prevent loss of control. Additionally this key fob can be used to prevent vehicle theft by disabling the vehicle for a period of time until it is re-enabled via the key fob or reset by cycling the microprocessor unit (104) power.

B. Software and Decision Process Description.

1. Software Description

This design may be implemented with many different types of microprocessors, some of which are language or code dependent. The software that is loaded into the microprocessor memory may be programmed in machine code, assembly language, pseudo-assembly language, or any higher language such as C, C++, Visual C, and Visual Basic.

2. Stop Decision Algorithm

The decision flowchart shown as FIG. 2, shows the flowchart the software uses when making a decision to stop the engine or system. Upon power on (200) the system initiates a short delay to allow the vehicle's voltage system to stabilize. Once the processor performs and passes its self-test diagnostic it determines if the transmission is in park or neutral (201). If the transmission is not in neutral or park it initiates an engine stop command (204). This prevents the engine from starting in gear. Once the processor determines the transmission is in park or neutral (201), it tests the operator engine stop or engine emergency stop switch status (202). If there is an engine stop initiated by the switch the processor will send an engine stop command (204) to the vehicle's onboard control system. If the emergency engine stop switch is not active (engine run position) the microprocessor will allow the engine to start (203).

Once the engine is started processor goes into its running loop (208) where it monitors the various sensors of the vehicle to determine rider and vehicle status. Some of the sensors that the processor monitors are transmission status, park or neutral (201), handbrake status (206), foot brake status (207) emergency stop switch status (202), and the key fob panic stop status (205). Depending on the sensor inputs the PCASS software may allow any given sensor to generate an interrupt to the software, and based on that, preempt the status of the control output signals and disable or shut down the vehicle. This software driven, decision-making process, may be a simple matrix, or artificial intelligence software depending on the requirements for that particular vehicle or system installation.

I claim the following:

1. A Processor Controlled Adaptive Safety System (PCASS) unit compromising a microprocessor unit, memory unit, sensor input and conditioning unit, output command and conditioning unit, remote receiver unit, and a power conditioner unit. The terms computer, microprocessor, processor, and controller are all synonymous terms used in describing this device.

2. That this device integrates the operator of a vehicle or system and mechanical/electrical sensors into the process of determining the qualifications of said operator, to operate said vehicle or system via microprocessor programming.

3. The PCASS software algorithm may use a deterministic matrix or artificial intelligence as the basis for determining whether the operator is qualified to operate said vehicle. In the event the operator in not qualified to operate the vehicle, the invention will degrade the performance or disable the vehicle or system and provide output for a status display, and output for the vehicle or system processor/controller.

4. Pursuant to claim #1, the PCASS system and software are capable of disabling said vehicle via a remote personal device such as a radio frequency transmitter/receiver system (key-fob). This enables supervised learning and riding said vehicle by another qualified operator. Additionally, this provides antitheft security by semi-permanently disabling said vehicle engine.

5. Pursuant to claim #4, the key fob transmitter/receiver system will utilize digital data encoding and incorporate a digital security code to prevent interference or compromising of the system.

6. Pursuant to claim #1, the PCASS unit will have an override switch that is externally accessible mounted on the unit itself in case the unit malfunctions or an emergency arises where the unit must be disabled, enabling any rider to operate the vehicle.

7. Pursuant to claim #1, the PCASS unit will be able to be connected to the vehicle's wiring harness via in-line connectors or through tap connectors. Said unit will mount under the seat or saddle of the vehicle.

8. The Processor Controlled Adaptive Safety System set forth in above claims may be used in combination with external sensors to provide safety and security for a manufacturing processes whereby an operational error may result in injury, damage or theft to a person or equipment.
